(19) United States
(12) Patent Application Publication
(10) Pub. No.: US 2025/0200872 A1
(43) Pub. Date: Jun. 19, 2025

(54) HARDWARE ACCELERATOR QUAD PRIMITIVE MODE FOR SHADERS

(71) Applicant: Advanced Micro Devices, INC., Santa Clara, CA (US)

(72) Inventors: Max Oberberger, Munich (DE); Matthaeus G. Chajdas, Munich (DE)

(21) Appl. No.: 18/539,958

(22) Filed: Dec. 14, 2023

(51) Int. Cl. G06T 15/80; G06T 15/10

(52) U.S. Cl. CPC G06T 15/80; G06T 15/10

(57) ABSTRACT

A processing unit processes primitives in a hardware accelerated mode. In the hardware accelerated mode the processing unit employs a mesh shader to provide primitives to other stages of a graphics pipeline as a set of four vertices, with each of the four vertices representing the vertex of a corresponding quad. In some cases, one or more of the vertices provided by the mesh shader is referenced by multiple quad primitives. The rasterizer of the graphics pipeline processes each quad primitive as a set of two triangles, but in the hardware accelerated mode, pixel shader operations are provided with vertex data from all four vertices of the corresponding quad primitive.

### BACKGROUND

Some processing systems employ a graphics processing unit (GPU) to perform graphical operations in an accelerated fashion relative to a host processor of the system. In some cases, the GPU is configured to generate and process image frames for display at a display device. To generate the images, the GPU identifies (e.g., based on draw commands received from the host processor) one or more objects, referred to as primitives, to be rendered. The GPU assembles the primitives, processes the primitives according to one or more vertex operations, then rasterizes the primitives as sets of triangles into a pixel flow for further processing, such as pixel shader processing, and then renders the final image frame for display based on the processed primitives. However, in some cases, the software that generates the primitives represents those primitives as quadrilateral (referred to as quad) surfaces. Conversion of these quad surfaces into triangles sometimes results in the GPU generating image frames with visual artifacts and distortions.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that includes a processing unit with a hardware-accelerated quad primitive mode in accordance with some embodiments.

FIG. 2 is a block diagram illustrating an example of the processing unit of FIG. 1 processing a quad primitive in a hardware-accelerated mode in accordance with some embodiments.

FIG. 3 is a block diagram illustrating an example of the processing unit of FIG. 1 operating in different modes, includes a quad primitive mode and a non-quad primitive mode in accordance with some embodiments.

FIG. 4 is a flow diagram of a method of processing quad primitives in a hardware-accelerated mode at a processing unit in accordance with some embodiments.

FIG. 5 is a block diagram of the processing unit of FIG. 1 implementing a graphics pipeline that operates in both the quad primitive mode and the non-quad primitive mode in accordance with some embodiments.

### DETAILED DESCRIPTION

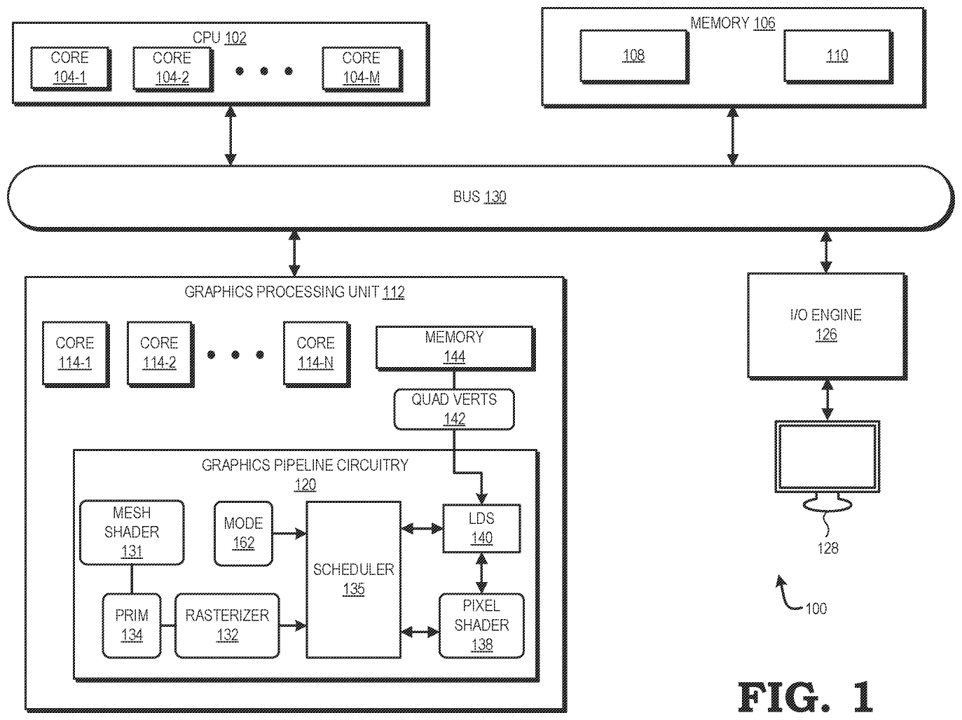

FIGS. 1-5 illustrate techniques for processing primitives at a processing unit in a hardware accelerated mode in accordance with some embodiments. In the hardware accelerated mode the processing unit employs a mesh shader to provide primitives to other stages of a graphics pipeline as a set of four vertices, with each of the four vertices representing the vertex of a corresponding quad. In some cases, one or more of the vertices provided by the mesh shader is referenced by multiple quad primitives. The rasterizer of the graphics pipeline processes each quad primitive as a set of two triangles, but in the hardware accelerated mode, pixel shader operations are provided with vertex data from all four vertices of the corresponding quad primitive. This improves the accuracy and fidelity of the primitive processing, and thus reduces visual artifacts and distortions in the resulting image frame.

To illustrate, a conventional GPU employs a rasterizer that rasterizes each quad primitive as two triangle primitives, with each triangle primitive including three of the four vertices of the quad primitive. To process the quad primitive at, for example, a pixel shader, a scheduler of the GPU loads the vertices of the triangle primitives to a local data store (LDS), and the pixel shader employs the stored vertices to perform pixel shading operations. However, because the quad primitive is represented as two sets of three vertices (that is, as two triangles), in some cases the pixel shading operations are executed in such a way that one of the vertices of the quad is omitted. For example, some shading operations, such as barycentric interpolation, are based on the location of one or more points relative to the vertices of the corresponding primitive. In the case of a quad primitive, the pixel shader executes these operations using the three vertices of each triangle primitive, rather than all four vertices of the quad, resulting in the operations incorrectly representing the resulting quad. In at least some cases, the incorrect representation of the quad results in visual artifacts or distortions in the resulting image frame for display. Some software pixel shaders address this issue by loading to the LDS all four of the vertices of the quad for each of the corresponding two triangle primitives, but this results in a high amount of data duplication and thus consumption of a relatively high amount of memory and power resources. For example, a software pixel shader in combination with programmable parts of the geometry processing stage, such as programmable mesh-, vertex-, geometry-, or tessellation-shader can encode and store vertex attributes, such that a GPU scheduler loads vertex attributes for all four vertices of the quad to the LDS. However, this requires increasing the vertex attribute size and duplicating vertex information.

In contrast to this conventional approach, a GPU employing the techniques described herein includes a hardware accelerated quad mode. In the quad mode, the rasterizer of the GPU rasterizes a quad primitive as triangles, but the scheduler automatically loads all four vertices of the quad to the LDS. In particular, the scheduler loads all four vertices as a single record or set of vertices and does not duplicate the vertices for each triangle. This allows the pixel shader to perform barycentric interpolation and other operations using all four vertices of the quad, reducing visual artifacts and distortions in the resulting image frame. Furthermore, because the vertices of the quad are not duplicated for each triangle, the memory and power resources needed to generate the image frame are reduced.

Referring now to FIG. 1, a processing system 100 configured to shade interpolated frames using a multi-channel disocclusion mask is presented, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 130 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at graphics processing unit (GPU) 112. GPU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. GPU 112 is configured to render a set of rendered frames 118 each representing respective scenes within a screen space (e.g., the space in which a scene is displayed) according to one or more applications 110 for presentation on a display 128.

As an example, GPU 112 renders graphics objects (e.g., sets of primitives) for a scene to be displayed so as to produce pixel values representing a rendered frame 118. GPU 112 then provides the rendered frame 118 (e.g., pixel values) to display 128. These pixel values, for example, include color values (YUV color values, RGB color values), depth values (z-values), or both. After receiving the rendered frame 118, display 128 uses the pixel values of the rendered frame 118 to display the scene including the rendered graphics objects. To render the graphics objects, GPU 112 implements processor cores 114-1 to 114-N that execute instructions concurrently or in parallel. For example, GPU 112 executes instructions, operations, or both from a graphics pipeline 120 using processor cores 114 to render one or more graphics objects. The graphics pipeline 120 includes, for example, one or more steps, stages, or instructions to be performed by GPU 112 in order to render one or more graphics objects for a scene, as described further below.

In embodiments, one or more processor cores 114 of GPU 112 each operate as a compute unit configured to perform one or more operations for one or more instructions received by GPU 112. These compute units each include one or more single instruction, multiple data (SIMD) units that perform the same operation on different data sets to produce one or more results. For example, GPU 112 includes one or more processor cores 114 each functioning as a compute unit that includes one or more SIMD units to perform operations for one or more instructions from a graphics pipeline 116. To facilitate the performance of operations by the compute units, GPU 112 includes one or more command processors (not shown for clarity). Such command processors, for example, include circuitry configured to execute one or more instructions from a graphics pipeline 116 by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents GPU 112 as having three processor cores (114-1, 114-2, 114-N) representing an N number of cores, the number of processor cores 114 implemented in GPU 112 is a matter of design choice. As such, in other implementations, GPU 112 can include any number of processor cores 114. Some implementations of GPU 112 are used for general-purpose computing. For example, in embodiments, GPU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, GPU 112 executes the instructions for the video tasks, physical simulation tasks, computational tasks, and fluid dynamics tasks. GPU 112 then stores information in the memory 106 such as the results of the executed instructions.

In some embodiments, processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the memory 106, GPU 112, or the central processing unit (CPU) 102.

In embodiments, processing system 100 also includes CPU 102 that is connected to the bus 130 and therefore communicates with GPU 112 and the memory 106 via the bus 130. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and GPU 112 have an equal number of processor cores 104, 114 while in other implementations, CPU 102 and GPU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to GPU 112.

The GPU 112 is configured to execute the draw calls, and render resulting image frames for display, using the graphics pipeline 120. In particular, the graphics pipeline 120 is circuitry configured to execute sets of graphics operations in pipelined fashion to render image frames for display at the display device 128. The graphics pipeline 120 is configured to render graphics objects as images that depict a scene which has three-dimensional geometry in virtual space (also referred to herein as “screen space”), but potentially a two-dimensional geometry. Example graphics pipeline 120 typically receives a representation of a three-dimensional scene, processes the representation, and outputs a two-dimensional raster image. The stages of example graphics pipeline 120 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

To support the graphics pipeline 120 the GPU 112 includes a memory 144. The memory 144 includes, for example, a hierarchy of one or more memories or caches that are used to implement buffers and store vertex data, texture data, and the like, for example graphics pipeline 120. In some embodiments, the memory 144 is implemented within processing system 100 using respective portions of system memory 106. In embodiments, the memory 144 includes or otherwise has access to one or more caches, one or more random access memory (RAM) units, video random access memory unit(s) (not pictured for clarity), one or more processor registers (not pictured for clarity), and the like.

The graphics pipeline 120, for example, includes stages that each perform respective functionalities, including a mesh shader 131, a rasterizer 132, a scheduler 135, a pixel shader 138, and a local data store 140. For example, these stages represent subdivisions of functionality of example graphics pipeline 120. Each stage is implemented partially or fully as shader programs executed by GPU 112. According to embodiments, the mesh shader stage of example graphics pipeline 120 represents the front-end geometry processing portion of example graphics pipeline 120 prior to rasterization.

In some embodiments, the mesh shader 131 includes an input assembler stage configured to access information from the memory 144 that is used to define objects that represent portions of a model of a scene. For example, in various embodiments, the input assembler stage includes circuitry configured to read primitive data (e.g., points, lines and/or triangles) from user-filled buffers (e.g., buffers filled at the request of software executed by processing system 100, such as an application 110) and assembles the data into primitives that will be used by other pipeline stages of the example graphics pipeline 120. “User,” as used herein, refers to an application 110 or other entity that provides shader code and three-dimensional objects for rendering to example graphics pipeline 120. In embodiments, the input assembler is configured to assemble vertices into several different primitive types (e.g., line lists, triangle strips, primitives with adjacency) based on the primitive data include in the user-filled buffers and formats the assembled primitives for use by the rest of example graphics pipeline 120.

According to embodiments, example graphics pipeline 120 operates on one or more virtual objects defined by a set of vertices set up in the screen space and having geometry that is defined with respect to coordinates in the scene. For example, the input data utilized in example graphics pipeline 120 includes a polygon mesh model of the scene geometry whose vertices correspond to the primitives processed in the rendering pipeline in accordance with aspects of the present disclosure, and the initial vertex geometry is set up in the memory 144 during an application stage implemented by, for example, CPU 102.

The mesh shader 131 of example graphics pipeline 120, is generally configured to perform processing operations based on sets of vertices and primitives, sometimes referred to as meshlets. For example, in some embodiments a task shader (not shown) or other circuitry of the graphics pipeline 120 is generally configured to generate one or more meshes based on the scene to be rendered. Each mesh includes sets of vertices forming one or more primitives, and based on the meshes and commands received from the CPU 102 the mesh shader performs operations such as culling and level-of-detail operations.

In embodiments, one or more mesh shaders are implemented partially or fully as mesh shader programs to be executed on one or more processor cores 114 (e.g., one or more processor cores 114 operating as compute units). Some embodiments of shaders such as the mesh shader implement massive single-instruction-multiple-data (SIMD) processing so that multiple vertices are processed concurrently. In at least some embodiments, example graphics pipeline 120 implements a unified shader model so that all the shaders included in example graphics pipeline 120 have the same execution platform on the shared massive SIMD units of the processor cores 114. Once front-end processing at the mesh shader 131 is complete, the scene is defined by a set of triangles having parameter values stored in the memory 144. The rasterizer 132 includes circuitry configured to accept and rasterize the triangles that are generated upstream. The rasterizer 132 is configured to perform shading operations and other operations such as clipping, perspective dividing, scissoring, viewport selection, and the like. In embodiments, the rasterizer 132 is configured to generate a set of pixels that are subsequently processed pixel shader 138 of the example graphics processing pipeline. In some implementations, the set of pixels includes one or more tiles. In one or more embodiments, the rasterizer 216 is implemented by fixed-function hardware.

The pixel shader 138 includes circuitry configured to receive a pixel flow (e.g., the set of pixels generated by the rasterizer 132) as an input and output another pixel flow based on the input pixel flow. To this end, a pixel shader 138 is configured to calculate pixel values for screen pixels based on the primitives generated upstream and the results of rasterization. It will be appreciated that, while a single pixel shader 138 is illustrated at FIG. 1 for clarity, in some embodiments the graphics pipeline 120 implements multiple pixel shaders to execute corresponding operations, and these multiple pixel shaders are collectively represented as pixel shader 138 (that is, in different embodiments pixel shader 138 corresponds to or represents multiple pixel shaders).

In embodiments, the pixel shader 138 is configured to apply textures from a texture memory, which, according to some embodiments, is implemented as part of the memory 144. The pixel values generated by one or more pixel shaders 138 include, for example, color values, depth values, and stencil values, and are stored in one or more corresponding buffers that collectively form a frame buffer (not shown). In some embodiments, example graphics pipeline 120 implements multiple frame buffers including front buffers, back buffers and intermediate buffers such as render targets, frame buffer objects, and the like. Operations for the pixel shader 138 are performed by a shader program that executes on the processor cores 114.

According to embodiments, the pixel shader 138, or another shader, accesses shader data, such as texture data, stored in the memory 144. Such texture data defines textures which represent bitmap images used at various points in example graphics pipeline 120. For example, the pixel shader 138 is configured to apply textures to pixels to improve apparent rendering complexity (e.g., to provide a more “photorealistic” look) without increasing the number of vertices to be rendered. In another instance, the mesh shader 131 uses texture data to modify primitives to increase complexity, by, for example, creating or modifying vertices for improved aesthetics.

To enhance the efficiency of the pixel shaders (e.g., pixel shader 138), the graphics pipeline 120 includes a local data store (LDS) 140. The LDS 140 is memory configured to provide lower latency and higher memory bandwidth to the pixel shaders, relative to the memory 144. Thus, for example, in some embodiments the LDS 140 employs a faster memory architecture or design than the memory 144, is addressed by the pixel shaders using a faster addressing approach (e.g., using explicit addressing rather than implicit addressing) than the memory 144, and the like, or any combination thereof. As described further below, the vertex attribute information used by the pixel shaders to perform texturing, and other shader operations is stored at the LDS 140. Thus, when performing, for example, a mesh shading operation based on one or more primitives, the pixel shader 138 retrieves the vertex attributes for the one or more primitives from the LDS 140 and employs the retrieved vertex attributes to perform one or more operations (e.g., translation, rotation, transformation, and interpolation) to generate the output pixel flow.

The scheduler 135 is circuitry generally configured to receive primitive information from the rasterizer 132 and, based on the primitive information and the received draw commands, initialize and schedule pixel shaders, such as the pixel shader 138 for execution. To initialize a pixel shader for execution, loading circuitry at the scheduler 135 loads data from the memory 144 to the LDS 140. For example, the scheduler 135 loads vertex attribute information, representing the vertices of the primitives to be processed by the pixel shader, to the LDS 140. The scheduler 135 then schedules the pixel shader 138 for execution by, for example, loading one or more instructions of the pixel shader 138 at an instruction buffer of at least one of the processor cores 114.

In some embodiments, the graphics pipeline 120 includes additional stages not illustrated at FIG. 1 for clarity such as an output merger stage that includes circuitry configured to perform operations such as z-testing, alpha blending, stenciling, or any combination thereof on the pixel values of each pixel received from the pixel shader 138 to determine the final color for a screen pixel. For example, the output merger stage combines various types of data (e.g., pixel values, depth values, stencil information) with the contents of the color buffer, depth buffer, and, in some embodiments, the stencil buffer and stores the combined output back into the frame buffer. The output of the output merger stage can be referred to as rendered pixels that collectively form a rendered frame 118. In one or more implementations, the output merger stage is implemented by fixed-function hardware.

In some implementations, the graphics pipeline 120 is configurable (e.g., based on an explicit instruction from the CPU 102 or based on compiler-generated configuration information) to operate in different modes, referred to herein as a non-quad mode and a quad mode. The mode is indicated by a mode indicator 162, which in different embodiments is a flag, a register setting (e.g., a value stored at a register) or other indicator. Further, in different embodiments, and as described further below, the mode indicator 162 is set by an explicit instruction, based on application attribute data, and the like, or any combination thereof.

In both the non-quad mode and the quad mode, the rasterizer 132 rasterizes each received primitive, including quad primitives (that is, primitives representing quadrilaterals), as a corresponding set of triangles. In the non-quad mode, quad primitives are represented at the LDS 140 by the vertex attributes of the corresponding triangles (that is, by two sets of three vertices, each set representing a different one of the two triangles that form the corresponding quad). In the quad mode, quad primitives are represented at the LDS 140 by all four vertex attributes of the quad (that is, by one set of vertices, representing all four vertexes that form the corresponding quad). In the quad mode, the pixel shader 138 is able to perform operations that are tailored for quad primitives in a more efficient and accurate fashion compared to performing those operations (or analogous operations) using the vertices of the corresponding triangles.

To illustrate via an example, in some embodiments the application 110 is a program designed and implemented to represent surfaces of one or more graphics objects as quads. For example, in some implementations the application 110 represents a graphics object as a set of Catmull-Clark subdivision surfaces. Furthermore, the application 110 is implemented to include operations (e.g., texturing operations) that require the pixel shader 138 to perform interpolations based on the vertices of the quads. In the non-quad mode, the quads are represented as two sets of three vertices at the LDS 140, with one of the vertices of a quad missing from each set. This causes the shader 138 to perform the interpolation operations using only the three vertices of each triangle. This in turn causes the interpolation operations to have inaccuracies, relative to the intended texturing effects, resulting in textures applied to the quads that have visual distortions or other errors. In the quad mode, all four vertices of the quad are stored at the LDS 140 and therefore are directly accessible by the pixel shader 138. This allows the pixel shader 138 to perform operations, such as barycentric interpolation operations, that are tailored for quad primitives, improving the visual result of texturing and other operations.

To illustrate via, an example, in some embodiments the GPU 112 receives an instruction (not shown) from the application 110 setting the mode indicator 162 to indicate the quad mode. In response, circuitry of the graphics pipeline 120 is set to the quad mode. For example, the scheduler 135 configures its loading circuitry to load quad vertices attributes from the memory 144 to the LDS 140. Subsequently, the application 110 issues a draw command to the GPU 112 to draw a set of primitives, including primitives represented by the application 110 as a set of quad primitives, such as a set of Catmull-Clark subdivision surfaces. In response to the draw command, the mesh shader 131 assembles and performs mesh shading for the quad primitives, including a quad primitive 134. The mesh shader 131 also stores vertex attribute information for the quad primitive 134 at the memory 144. In particular, the mesh shader 131 stores vertex attribute information for all four of the vertices of the quad primitive 134. The rasterizer 132 rasterizes the quad primitive 134 as a set of two triangles, and provides information, such as position information, defining the two triangles to the scheduler 135.

In response to receiving the position information, and based on the received draw command, the scheduler 135 initializes the pixel shader 138 by transferring vertex attribute information for the primitives to be processed, including for the quad primitive 134, from the memory 144 to the LDS 140. Because the graphics pipeline 120 has been placed in the quad mode, the scheduler 135 loads all four vertices of the quad primitive 134 to the LDS 140. The scheduler 135, and in particular the loading circuitry, thereby passes all four vertices of the quad primitive 134 to the pixel shader 138 for processing. These four vertices are illustrated at FIG. 1 as quad vertices 142. The scheduler 135 loads the quad vertices 142 from the memory 144 to the LDS 140 so that the quad vertices 142 are accessible to the pixel shader 138 as a single set of four vertices and does not load the quad vertices as two sets of triangle vertices. The quad vertices 142 are thus passed to and directly accessible by the pixel shader 138 as quad vertices, allowing the pixel shader 138 to operate on the passed quad vertices 142 directly, without converting the vertices from a different shape (e.g., a triangle) and therefore performing at least some operations, such as barycentric interpolation, more efficiently.

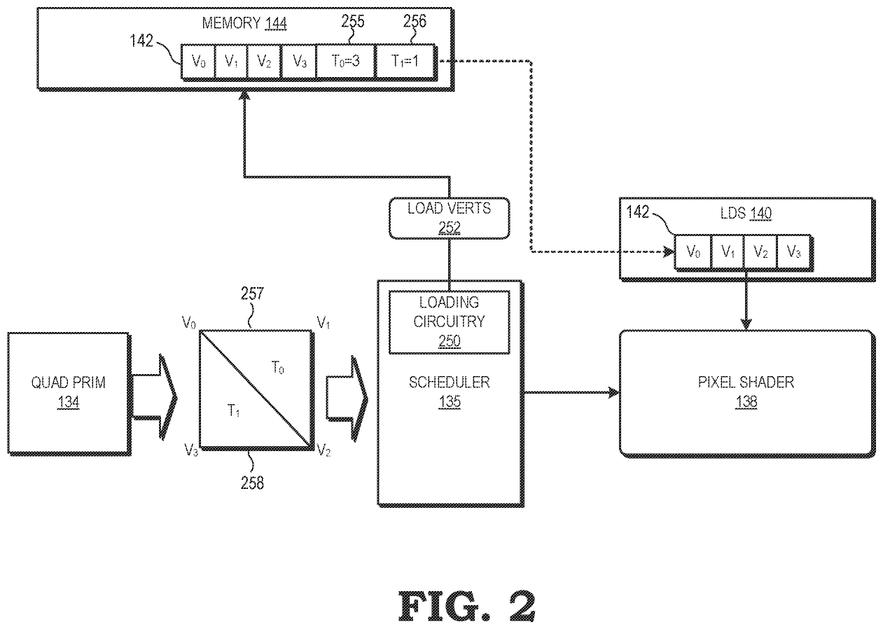

FIG. 2 is a block diagram illustrating an example of the scheduler 135 loading the quad vertices 142 to the LDS 140 while in the quad mode, in accordance with some embodiments. In the illustrated example, to initialize the pixel shader 138, the LDS 140 employs loading circuitry 250 to load the quad vertices 142 from the memory 144. In some embodiments, the loading circuitry 250 is configured to include a set of selectable hardware paths, including one path configured to load quad primitive vertices from the memory 144 as sets of triangles, and a different path configured to load quad primitive vertices from the memory 144 as quad vertices (that is, as four vertices). In some embodiments, the scheduler 135 selects the path of the loading circuitry 250 based on mode selection information provided by an instruction of the application 110, by compiler information indicating attributes of the application 110, and the like, or any combination thereof.

It is assumed for the example of FIG. 2 that the mode indicator 162 indicates the quad mode, and therefore the graphics pipeline 120 has set the loading circuitry 250 to load the quad vertices 142 to the LDS 140 as a set of quad vertices, rather than as multiple sets of triangle vertices. Accordingly, to initialize the vertex shader 138, the scheduler 135 causes the loading circuitry 250 to issue a load vertices command 252 to the memory 144. In some embodiments, the load vertices command 252 is a memory load command, or set of commands, that identifies the memory address for each of the four vertices, designated V₀, V₁, V₂, and V₃, of the quad vertices 142. For example, in the illustrated embodiment, the mesh shader 131 has stored primitive attribute information 255 and 256 for the quad primitive 134 to indicate which additional vertex is to be loaded by the scheduler 135 for each triangle. To illustrate, the quad primitive 134 includes four vertices, designated V₀, V₁, V₂, and V₃. The rasterizer 132 rasterizes the quad primitive 134 based on two triangles, designated triangles 257 and 258 that together form the quad primitive 134. In particular, the triangle 258 is formed by the vertices V₂, V₃, and V₀ and the triangle 257 is formed by the vertices V₀, V₁, V₂. The mesh shader 131 stores the primitive attribute information to indicate which additional vertex is to be loaded when the scheduler receives position information for one of the triangles 257 and 258. In particular, the attribute information 255 indicates that, for triangle 257, the additional vertex V₃ is to be loaded, and attribute information 256 indicates that, for triangle 258, the additional vertex V₁ is to be loaded. When the scheduler receives position information for a triangle from the rasterizer 132, the scheduler 135 accesses the corresponding primitive attribute information to find the fourth vertex to be loaded. For example, in response to receiving the position information for the triangle 257, the scheduler 135 accesses the primitive attribute information 255 to identify the fourth vertex to be loaded and controls the loading circuitry 250 to load all four vertices of the quad primitive 134. Thus, in response to the load vertices command 252, the memory 144 sends all four vertices of the quad vertices 142 to the LDS 140. The pixel shader 138 then accesses the quad vertices 142 at the LDS 140 directly as a set of quad vertices and uses the quad vertices 142 to perform one or more pixel shading operations.

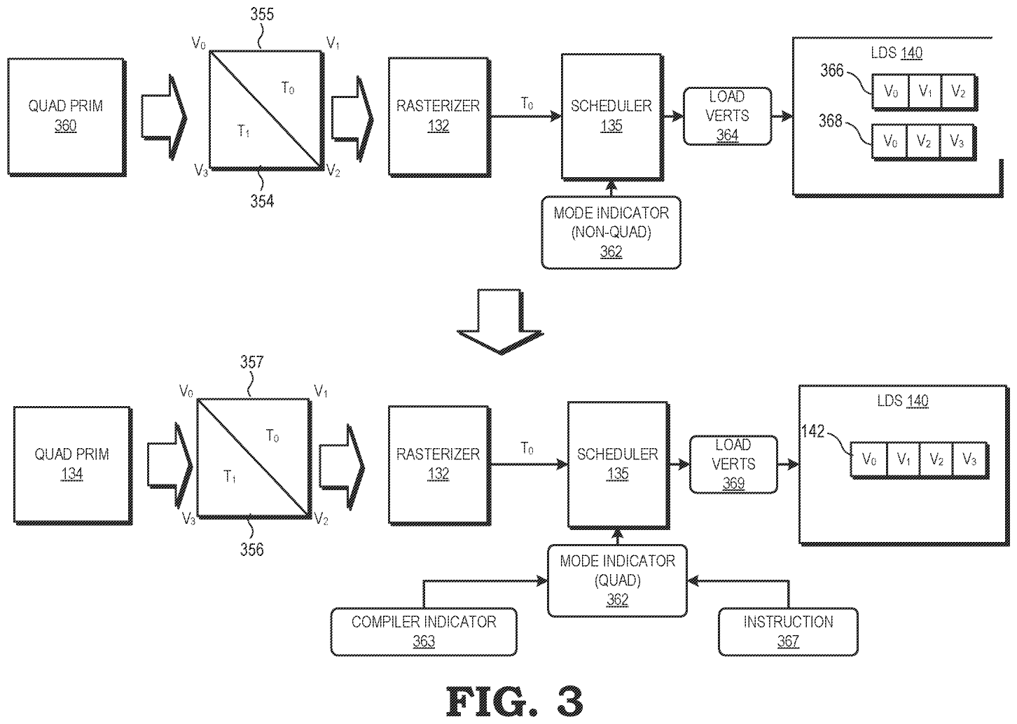

FIG. 3 is a block diagram illustrating an example of the graphics pipeline 120 operating, at different times, in the non-quad mode and the quad mode in accordance with some embodiments. In the depicted example, at a first time a mode indicator 362 (corresponding to the mode indicator 162 of FIG. 1) indicates that the graphics pipeline 120 is set to the non-quad mode. In some embodiments, the mode indicator 362 is a flag, a value stored at a control or settings register, and the like. Furthermore, in some embodiments the mode indicator 362 is set by an explicit mode setting instruction 367 issued by an application. For example, in some embodiments the instruction set for the processing system 100 includes an instruction 367 that, when issued, sets the mode indicator 362 to indicate either the quad mode or the non-quad mode, wherein the selected mode is indicated by a field of the instruction. A programmer of an application includes the instruction 367 in the application to set the mode of the graphics pipeline 120 according to whether the application is representing and processing primitives as quads or as sets of triangles. In some cases, an application includes the instruction 367 multiple times to select different modes over time, as the representation of primitives changes, thereby allowing the application to select different primitive representations according to which representation is most efficient for a particular shader or other processing.

In other embodiments, the mode indicator 362 is set based on information generated by a compiler (e.g., compiler indicator 363). For example, in some embodiments the application 110 is compiled by the compiler for execution by the processing system 100. During compilation, the compiler generates control information to set various aspects of the processing system 100, including the compiler indicator 363, to set the mode indicator 362. In some embodiments, the compiler generates the control information based on program attribute information explicitly included in the program code for the application 110 by a programmer. In other embodiments, the compiler analyzes the program code automatically to determine the program attribute information. When an operating system of the processing system 100 loads the application 110 for execution, the application 110 provides the control information, causing the processing system 100 to set the mode indicator 362 to the indicated mode (quad mode or non-quad mode). For example, in some embodiments, loading of the application 110 by the operating system includes storing a value at a control register to set the condition for the mode indicator 362, and thereby indicate the quad mode or the non-quad mode.

As noted above, in the example of FIG. 3, at a first time the mode indicator 362 has been set to indicate the non-quad mode. While in the non-quad mode the rasterizer 132 receives a quad primitive 360 from the mesh shader 131. In response, the rasterizer 132 rasterizes the quad primitive 360 based on a set of two triangles, designated triangles 354 and 355. In particular, the quad primitive 360 includes four vertices, designated V₀, V₁, V₂, and V₃. The rasterizer 132 rasterizes the quad primitive 360 based on the triangle 354 as formed by the vertices V₂, V₃, and V₀ and the triangle 355 as formed by the vertices V₀, V₁, V₂.

The rasterizer 132 provides position information for the triangles 354 and 355 to the scheduler 135. In response, the scheduler 135 initializes the pixel shader 138 by loading pixel information for the quad primitive 360 to the LDS 140. Because the graphics pipeline 120 is in the non-quad mode, the loading circuitry 250 of the scheduler 135 issues a load vertices command 364 loads the vertices for the triangles 354 and 355. In particular, the loading circuitry 250 loads, from the memory 144 to the LDS 140, a set of vertices 366, representing the vertices of the triangle 355, and a different set of vertices 368, representing the vertices of the triangle 354. Thus, in the non-quad mode, the scheduler 135 loads quad primitives to the LDS 140 as two sets of vertices representing the vertices of the triangle primitives that correspond to the quad primitive. The pixel shader 138 then processes the quad primitive using the vertices of the triangle primitives.

In the example of FIG. 3, at a different time the mode indicator 362 indicates the quad mode. While in the quad mode, the rasterizer 132 receives the quad primitive 134 from the mesh shader 131. In response, the rasterizer 132 rasterizes the quad primitive 134 based on a set of two triangles, designated triangles 356 and 357. In particular, similar to the quad primitive 360, the quad primitive 134 includes four vertices, designated V₀, V₁, V₂, and V₃. The rasterizer 132 rasterizes the quad primitive 360 such that the triangle 356 is formed by the vertices V₂, V₃, and V₀ and the triangle 357 is formed by the vertices V₀, V₁, V₂.

The rasterizer 132 provides position information for the triangles 356 and 357 to the scheduler 135. In response, the scheduler 135 initializes the pixel shader 138 by loading pixel information for the quad primitive 134 to the LDS 140. Because the graphics pipeline 120 is in the quad mode, the loading circuitry 250 of the scheduler 135 issues a load vertices command 369 that loads the vertices for the quad primitive 134 as a set of quad vertices, using the primitive attribute information as described above. In particular, the loading circuitry 250 loads, from the memory 144 to the LDS 140, the set of vertices 142, representing all four of the vertices of the quad primitive 134. Thus, in the quad mode, the rasterizer 132 still rasterizes all quad primitives as triangle primitives, but scheduler 135 loads quad primitives to the LDS 140 as a single set of four vertices representing the vertices of the quad. The graphics pipeline 120 thereby supports more efficient shader processing of quads, and without duplicating the vertex attribute information for a quad primitive at the LDS 140, thus conserving memory and power resources.

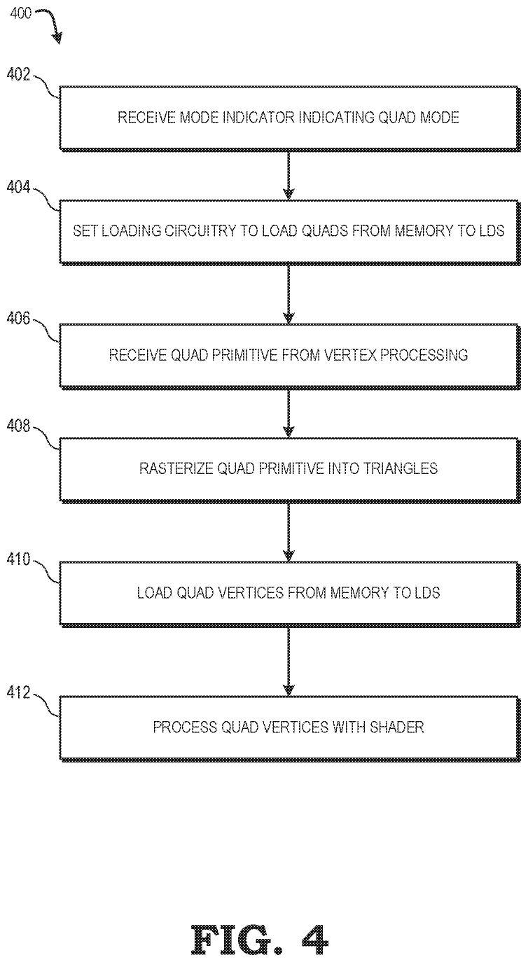

FIG. 4 illustrates a flow diagram of a method 400 of processing quad primitives in a hardware-accelerated mode at a processing unit in accordance with some embodiments. The method 400 is described with respect to an example implementation at the processing system 100 in accordance with some embodiments, but it will be appreciated that in other embodiments the method 400 is implemented at processing systems having different configurations, such as processing systems including more or fewer processing units, processing units of different types and configurations, and the like.

At block 402 the GPU 112 receives the mode indicator 362 indicating that the graphics pipeline circuitry 120 is to be placed in a quad mode. In some embodiments, the mode indicator 362 is a flag, a value stored at a control or settings register, and the like, and the GPU 112 identifies the state of the mode indicator 362 by reading the flag, register or other storage location. In some embodiments the value of the mode indicator 362 is set by an explicit mode setting instruction issued by an application, such as an instruction that sets the flag or stores a value at the register corresponding to the mode indicator 362. For example, in some embodiments the instruction set for the processing system 100 includes an instruction that, when issued, stores a value at a storage location (e.g., a register), and the stored value sets the mode indicator 362 to indicate either the quad mode or the non-quad mode. In other embodiments, the mode indicator 362 is set based on information generated by a compiler. For example, in some embodiments, loading of the application 110 by the operating system includes storing a value at a control register to set the condition for the mode indicator 362, and thereby indicate the quad mode or the non-quad mode. The value to be stored (and thus the state of the mode indicator 362) is set by a compiler of the application 110 based on one or more of an explicit indicator (e.g., a hint) in the source code being compiled (e.g., an indicator placed by a programmer of the source code), by an analysis of the source code by the compiler, and the like, or a combination thereof.

At block 404, in response to the mode indicator 362 indicating quad mode, the scheduler 135 configures the loading circuitry 250 to load quad vertices, rather than triangle vertices. For example, in some embodiments, the loading circuitry 250 is configured to include a set of selectable hardware paths, including one path configured to load quad primitive vertices from the memory 144 as sets of triangles, and a different path configured to load quad primitive vertices from the memory 144 as quad vertices (that is, as four vertices).

At block 406, the rasterizer 132 receives the quad primitive 134 from the mesh shader 131. At block 408, the rasterizer 132 rasterizes the quad primitive 134 into a set of triangles (e.g., triangles 356 and 357). Thus, even in the quad mode, the rasterizer 132 still rasterizes primitives into triangles. The quad mode thus supports efficient processing of quad primitives without requiring a redesign or modification of the rasterizer 132 itself.

At block 410, in response to the rasterizer 132 processing the quad primitive 134, the scheduler 135 causes the loading circuitry 250 to load the quad vertices 142 from the memory 144 to the LDS 140. The quad vertices 142 are stored at the LDS 140 as a unified set of vertices, and not as two sets of triangle vertices. At block 412, the pixel shader 138 executes one or more shading operations, such as barycentric interpolation operations, by accessing the quad vertices 142 at the LDS 140. Because the vertices of the quad primitive 134 are stored at the LDS 140 as one set of quad vertices, rather than as two sets of triangle vertices, the pixel shader 138 is designed and configured to load and perform operations using the quad vertices directly, rather than loading two sets of triangle vertices and reconstructing the quad primitive 134. The quad mode thus supports efficient processing of quads by saving both power and memory space at the processing system 100.

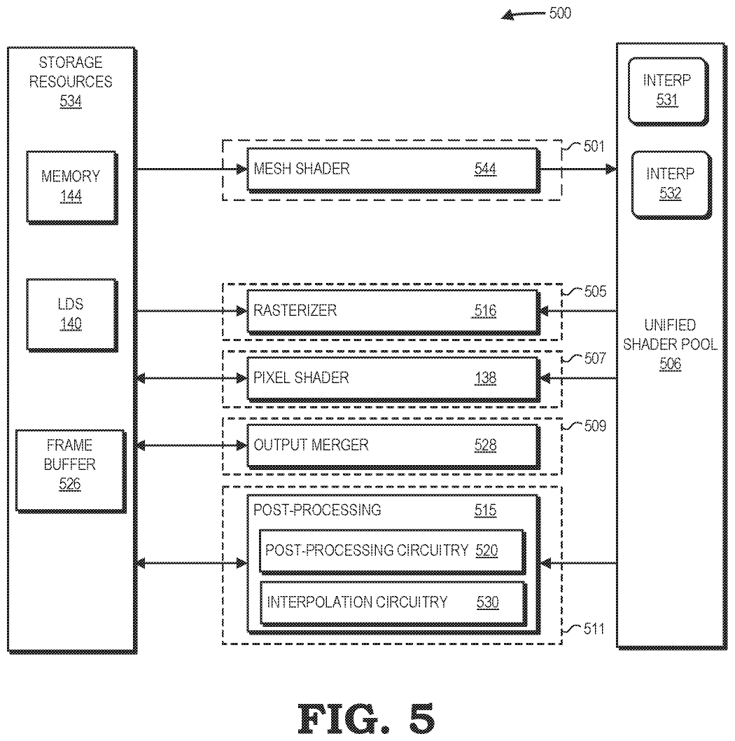

FIG. 5 a block diagram of an example implementation of a graphics pipeline 500 by the GPU 112 in accordance with some embodiments. In the illustrated example, Example graphics pipeline 200 typically receives a representation of a three-dimensional scene, processes the representation, and outputs a two-dimensional raster image. These stages of example graphics pipeline 200 process data that is initially properties at end points (or vertices) of a geometric primitive, where the primitive provides information on an object being rendered. Typical primitives in three-dimensional graphics include triangles, quads, and lines, where the vertices of these geometric primitives provide information on, for example, x-y-z coordinates, texture, and reflectivity.

According to embodiments, example graphics pipeline 200 has access to storage resources 534 (also referred to herein as “storage components”). Storage resources 534 include, for example, a hierarchy of one or more memories or caches that are used to implement buffers and store vertex data, texture data, and the like, for example graphics pipeline 500. In some embodiments, storage resources 534 refer to any processor-accessible memory utilized in the implementation of example graphics pipeline 500. For example, in some embodiments, the storage resources 534 include the memory 144 and LDS 140.

Example graphics pipeline 500, for example, includes stages that each perform respective functionalities. For example, these stages represent subdivisions of functionality of example graphics pipeline 500. Each stage is implemented partially or fully as shader programs executed by GPU 112. According to embodiments, stage 501 represents the front-end geometry processing portion of example graphics pipeline 500 prior to rasterization. Stages 507 to 511 represent the back-end pixel processing portion of example graphics pipeline 500. As described further below, in some embodiments each of the stages 501-511 is configurable to operate in either the quad mode or the non-quad mode. In either mode, each of the stages 501-511 is “aware” of the type of primitives (quad or triangle) being processed, and executes the corresponding operations based on the type of primitives being executed.

During mesh shader stage 501 of example graphics pipeline 500, a mesh shader 544 is configured to access information from the storage resources 534 that is used to define objects that represent portions of a model of a scene. For example, in various embodiments, mesh shader 544 includes circuitry configured to read primitive data (e.g., points, lines, triangles and quads) from user-filled buffers (e.g., buffers filled at the request of software executed by processing system 100, such as an application 110) and assembles the data into primitives that will be used by other pipeline stages of the example graphics pipeline 500. “User,” as used herein, refers to an application 110 or other entity that provides shader code and three-dimensional objects for rendering to example graphics pipeline 500. In embodiments, the mesh shader 544 is configured to assemble vertices into several different primitive types (e.g., line lists, triangle strips, quads) based on the primitive data include in the user-filled buffers and based on whether the pipeline 500 is in the quad mode or the non-quad mode. The mesh shader 544 formats the assembled primitives for use by the rest of example graphics pipeline 500.

According to embodiments, example graphics pipeline 500 operates on one or more virtual objects defined by a set of vertices set up in the screen space and having geometry that is defined with respect to coordinates in the scene. For example, the input data utilized in example graphics pipeline 500 includes a polygon mesh model of the scene geometry whose vertices correspond to the primitives processed in the rendering pipeline in accordance with aspects of the present disclosure, and the initial vertex geometry is set up in the storage resources 534 during an application stage implemented by, for example, CPU 102. In some embodiments, the mesh shader 544 is configured to process vertexes of the primitives and performs various operations such as transformations, skinning, morphing, lighting, or any combination thereof, to name a few.

In embodiments, one or more mesh shaders 544 are implemented partially or fully as mesh shader programs to be executed on one or more processor cores 114 (e.g., one or more processor cores 114 operating as compute units). Some embodiments of shaders such as the mesh shader 544 implement massive single-instruction-multiple-data (SIMD) processing so that multiple vertices are processed concurrently. In at least some embodiments, example graphics pipeline 500 implements a unified shader model so that all the shaders included in example graphics pipeline 500 have the same execution platform on the shared massive SIMD units of the processor cores 114. In such embodiments, the shaders, including one or more mesh shaders 544, are implemented using a common set of resources that is referred to herein as the unified shader pool 506.

Once mesh shading is complete, the scene is defined by a set of vertices which each have a set of vertex parameter values stored in the storage resources 534. In certain implementations, the vertex parameter values output from the mesh shader 544 includes positions defined with different homogeneous coordinates for different zones.

As described above, stages 505 to 511 represent the back-end processing of example graphics pipeline 500. The rasterizer stage 505 includes a rasterizer 516 having circuitry configured to accept and rasterize simple primitives that are generated upstream. The rasterizer 516 is configured to perform shading operations and other operations such as clipping, perspective dividing, scissoring, viewport selection, and the like. In embodiments, the rasterizer 516 is configured to generate a set of pixels that are subsequently processed in the pixel processing/shader stage 507 of the example graphics processing pipeline. In some implementations, the set of pixels includes one or more tiles. In one or more embodiments, the rasterizer 516 is implemented by fixed-function hardware. In some embodiments, the rasterizer 516 is configured to operate in either the quad mode or the non-quad mode. In the non-quad mode, the rasterizer 516 generates a set of triangles for subsequent processing by providing vertex attribute information for the vertices of each triangle to one or more subsequent stages, such as the pixel processing stage 507. Further, the rasterizer 516 indicates the provoking vertex for each triangle, wherein the subsequent stages (e.g., the pixel shader 518) identifies attributes for each vertex in a triangle (e.g., color) based on the identified provoking vertex. In the quad mode, the rasterizer 516 provides vertex information for triangles of each quad as described above but identifies the provoking vertex differently in the quad mode. For example, in some embodiments the rasterizer 516 identifies a vertex from one triangle of a quad (e.g., a vertex from triangle 354) as the provoking vertex for the other triangle of a quad (e.g., the triangle 355). That is, in some embodiments the rasterizer 516 indicates attributes for each pair of triangles in the quad mode, rather than for each triangle individually.

The pixel processing stage 507 of example graphics pipeline 500 includes one or more pixel shaders 138 that, as described above, include circuitry configured to receive a pixel flow (e.g., the set of pixels generated by the rasterizer 216) as an input and output another pixel flow based on the input pixel flow. To this end, a pixel shader 138 is configured to calculate pixel values for screen pixels based on the primitives generated upstream and the results of rasterization. In embodiments, the pixel shader 138 is configured to apply textures from a texture memory, which, according to some embodiments, is implemented as part of the storage resources 534. The pixel values generated by one or more pixel shaders 138 include, for example, color values, depth values, and stencil values, and are stored in one or more corresponding buffers, for example, a color buffer, a depth buffer, and a stencil buffer, respectively. The combination of the color buffer, the depth buffer, the stencil buffer, or any combination thereof is referred to as a frame buffer 526. In some embodiments, example graphics pipeline 500 implements multiple frame buffers 526 including front buffers, back buffers and intermediate buffers such as render targets, frame buffer objects, and the like. Operations for the pixel shader 138 are performed by a shader program that executes on the processor cores 114.

The pixel shader 138 is configured to operate in either the quad mode or the non-quad mode as described above. For example, in some embodiments in the quad mode the scheduler 135 initializes the pixel shader 138 by transferring vertex attribute information for the primitives to be processed, including for the quad primitive 134, from the memory 144 to the LDS 140. Because the graphics pipeline 120 has been placed in the quad mode, the scheduler 135 loads all four vertices of the quad primitive 134 to the LDS 140. The scheduler 135 loads the quad vertices 142 from the memory 144 to the LDS 140 so that the quad vertices 142 are accessible to the pixel shader 138 as a single set of four vertices and does not load the quad vertices as two sets of triangle vertices. The quad vertices 142 are thus directly accessible by the pixel shader 138 as quad vertices, allowing the pixel shader 138 to operate on the quad vertices 142 directly. In the non-quad mode, the scheduler 135 loads two sets of triangle vertices for each quad primitive to the LDS 140.

Within example graphics pipeline 500, the output merger stage 509 includes an output merger 528 accepting outputs from the pixel processing stage 507 and merges these outputs. As an example, in embodiments, output merger 528 includes circuitry configured to perform operations such as z-testing, alpha blending, stenciling, or any combination thereof on the pixel values of each pixel received from the pixel shader 138 to determine the final color for a screen pixel. For example, the output merger 528 combines various types of data (e.g., pixel values, depth values, stencil information) with the contents of the frame buffer 526 and stores the combined output back into the frame buffer 526. The output of the output merger stage 509 can be referred to as rendered pixels that collectively form a rendered frame. In one or more implementations, the output merger 528 is implemented by fixed-function hardware.

In embodiments, example graphics pipeline 500 includes a post-processing stage 511 implemented after the output merger stage 509. During the post-processing stage 511, post-processing circuitry 520 operates on the rendered frame stored (or individual pixels) stored in the frame buffer 526 to apply one or more post-processing effects, such as ambient occlusion or tone mapping, prior to the frame being output to the display. The post-processed frame is written to a frame buffer 526.

In some embodiments, the unified shader pool 506 stores different instructions, designated interpolation instruction 531 and interpolation instruction 532, that are configured to be executed by the interpolation circuitry 530 in the quad mode and the non-quad mode respectively. This allows the instruction 531 to implement interpolation techniques, such as barycentric interpolation, that are well suited to quad primitives and the instruction 532 to implement interpolation techniques better suited to triangle primitives.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to identifying a first primitive as a quad primitive at a processing unit, loading a set of all four vertices of the first primitive for a pixel shader; and
processing the first primitive with the pixel shader using the loaded set of all four vertices.

2. The method of claim 1, wherein loading all four vertices comprises:
loading attributes of the four vertices to a local data store used by the pixel shader to process the first primitive.

3. The method of claim 1, further comprising:
in response to identifying the first primitive as a quad primitive, reconfiguring loading circuitry of the processing unit from loading three vertices to loading four vertices to a memory associated with the pixel shader.

4. The method of claim 1, wherein processing the first primitive comprises interpolating the first primitive using the four vertices.

5. The method of claim 1, further comprising:
in response to identifying a second primitive as a non-quad primitive at the processing unit, loading three vertices of the second primitive for the pixel shader; and
processing the second primitive with the pixel shader using the loaded three vertices.

6. The method of claim 1, further comprising:
identifying the first primitive as a quad primitive based on an indicator generated by a compiler of code that generates the first primitive.

7. The method of claim 1, further comprising:
identifying the first primitive as a quad primitive in response to a software instruction.

8. A processing unit comprising:
scheduler circuitry to, in response to identifying a first primitive as a quad primitive at a processing unit, pass all four vertices of the first primitive to a pixel shader; and
shader circuitry to process the first primitive with the pixel shader using the passed four vertices.

9. The processing unit of claim 8, wherein the scheduler includes loading circuitry, the loading circuitry to:
load attributes of the four vertices to a local data store used by the pixel shader to process the first primitive.

10. The processing unit of claim 8, wherein the scheduler includes loading circuitry and wherein the scheduler is to:
in response to identifying the first primitive as a quad primitive, reconfigure the loading circuitry from loading three vertices to loading four vertices to a memory associated with the pixel shader.

11. The processing unit of claim 8, wherein the shader circuitry is to interpolate the first primitive using the four vertices.

12. The processing unit of claim 8, wherein:
the scheduler circuitry is to, in response to identifying a second primitive as a non-quad primitive at the processing unit, pass three vertices of the second primitive to the pixel shader; and
the shader circuitry is to process the second primitive with the pixel shader using the passed three vertices.

13. The processing unit of claim 8, wherein the scheduler circuitry is to:
identify the first primitive as a quad primitive based on an indicator generated by a compiler of code that generates the first primitive.

14. The processing unit of claim 8, wherein the scheduler circuitry is to:
identify the first primitive as a quad primitive in response to a software instruction.

15. A processing system, comprising:
a bus;
a first processing unit to issue a command via the bus;
a second processing unit to receive the command from the first processing unit, and comprising:
scheduler circuitry to, in response to identifying a first primitive as a quad primitive at a processing unit, load all four vertices of the first primitive for a pixel shader; and
shader circuitry to process the first primitive with the pixel shader using the loaded set of all four vertices.

16. The processing system of claim 15, wherein the scheduler circuitry includes loading circuitry, the loading circuitry to:
load attributes of the four vertices to a local data store used by the shader to process the first primitive.

17. The processing system of claim 15, wherein the scheduler circuitry includes loading circuitry and wherein the scheduler is to:
in response to identifying the first primitive as a quad primitive, reconfigure the loading circuitry from loading three vertices to loading four vertices to a memory associated with the pixel shader.

18. The processing system of claim 15, wherein the shader circuitry is to interpolate the first primitive using the four vertices.

19. The processing system of claim 15, wherein:
the scheduler circuitry is to, in response to identifying a second primitive as a non-quad primitive at the processing unit, load three vertices of the second primitive to the pixel shader; and
the shader circuitry is to process the second primitive with the pixel shader using the loaded three vertices.

20. The processing system of claim 15, wherein the scheduler circuitry is to:
identify the first primitive as a quad primitive based on an indicator generated by a compiler of code that generates the first primitive.
